(19) United States
(12) Patent Application Publication
(10) Pub. No.: US 2020/0363212 A1
(43) Pub. Date: Nov. 19, 2020

(54) MOBILE BODY, LOCATION ESTIMATION DEVICE, AND COMPUTER PROGRAM

(71) Applicant: Nidec Corporation, Kyoto (JP)

(72) Inventors: Shinji SUZUKI, Kyoto (JP); Tetsuo SAEKI, Kyoto (JP); Masaji NAKATANI, Kyoto (JP)

(21) Appl. No.: 16/638,517

(22) PCT Filed: Aug. 14, 2018
(86) PCT No.: PCT/JP2018/030306

§ 371 Date: Feb. 12, 2020

(30) Foreign Application Priority Data
Sep. 4, 2017 (JP) 2017-169726

(51) Int. Cl. G01C 21/30; G05D 1/02; G01S 17/89; G01C 21/00; B62D 57/02

(52) U.S. Cl. CPC G01C 21/30; G05D 1/0274; G01S 17/89; G05D 1/101; B62D 57/02; G05D 2201/0217; G01C 21/3837

(57) ABSTRACT

A location estimation device includes an external sensor, a storage to store partial environmental maps including first and second partial environmental maps linked to each other based on a coordinate transformation relationship, and a location estimator to match scan data received from the external sensor against the partial environmental map so as to estimate the location and attitude of the vehicle. Upon movement of the estimated location of the vehicle from a location on the first partial environmental map to a location on the second partial environmental map, the location estimator determines, in accordance with the coordinate transformation relationship, a corresponding location and a corresponding attitude on the second partial environmental map that are associated with the estimated location and estimated attitude of the vehicle on the first partial environmental map, corrects, in accordance with a history of estimated locations and estimated attitudes of the vehicle on the first partial environmental map, the corresponding location and corresponding attitude on the second partial environmental map at a point of timing when matching to estimate the location and attitude of the vehicle on the second partial environmental map starts, and executes the matching by using, as initial values, the corresponding location and corresponding attitude that have been corrected.

### CROSS REFERENCE TO RELATED APPLICATIONS

This is a U.S. national stage of PCT Application No. PCT/JP2018/030306, filed on Aug. 14, 2018, and priority under 35 U.S.C. § 119(a) and 35 U.S.C. § 365(b) is claimed from Japanese Application No. 2017-169726, filed Sep. 4, 2017; the entire disclosures of each of which are hereby incorporated herein by reference.

### 1. FIELD OF THE INVENTION

The present disclosure relates to vehicles, location estimation devices, and computer programs.

### 2. BACKGROUND

Vehicles capable of autonomous movement, such as automated guided vehicles (or automated guided cars) and mobile robots, are under development.

Japanese Laid-Open Patent Publication No. 2010-092147 discloses an autonomous mobile device that performs localization by matching a preliminarily prepared partial map against a local map acquired from a laser range finder.

In matching the local map against the partial map, the autonomous mobile device disclosed in Japanese Laid-Open Patent Publication No. 2010-092147 calculates a moving amount of the device itself by using an output from a rotary encoder (hereinafter simply referred to as an “encoder”) attached to a motor or a driving wheel.

### SUMMARY

Example embodiments of the present disclosure provide vehicles that are each able to perform localization without using an output from an encoder.

In a non-limiting and illustrative example embodiment of the present disclosure, a vehicle includes an external sensor to scan an environment so as to periodically output scan data, a storage to store a plurality of partial environmental maps including a first partal environmental map and a second partial environmental map linked to each other based on a coordinate transformation relationship, and a location estimator match the scan data against one of the plurality of partial environmental maps read from the storage so as to estimate a location and an attitude of the vehicle. Upon movement of the estimated location of the vehicle from a location on the first partial environmental map to a location on the second partial environmental map, the location estimator determines, in accordance with the coordinate transformation relationship, a corresponding location and a corresponding attitude on the second partial environmental map that are associated with the estimated location and estimated attitude of the vehicle on the first partial environmental map. Then, it corrects, in accordance with a history of estimated locations and estimated attitudes of the vehicle on the first partial environmental map, the corresponding location and corresponding attitude on the second partial environmental map at a point of timing when matching to estimate the location and attitude of the vehicle on the second partial environmental map starts. Next, it performs the matching to estimate the location and attitude of the vehicle on the second partial environmental map by using, as initial values, the corresponding location and corresponding attitude that have been corrected.

In a non-limiting and illustrative example embodiment, a location estimation device according to the present disclosure is a location estimation device of a vehicle. The location estimation device is connected to an external sensor to scan an environment so as to periodically output scan data, and a storage to store a plurality of partial environmental maps including a first partial environmental map and a second partial environmental map linked to each other based on a coordinate transformation relationship. The location estimation device includes a processor, and a memory to store a computer program to operate the processor. Upon movement of an estimated location of the vehicle from a location on the first partial environmental map to a location on the second partial environmental map, the processor performs, in accordance with a command included in the computer program: determining, in accordance with the coordinate transformation relationship, a corresponding location and a corresponding attitude on the second partial environmental map that are associated with the estimated location and estimated attitude of the vehicle on the first partial environmental map; correcting, in accordance with a history of estimated locations and estimated attitudes of the vehicle on the first partial environmental map, the corresponding location and corresponding attitude on the second partial environmental map at a point of timing when matching to estimate the location and attitude of the vehicle on the second partial environmental map starts; and executing the matching to estimate the location and attitude of the vehicle on the second partial environmental map by using, as initial values, the corresponding location and corresponding attitude that have been corrected.

In a non-limiting and illustrative example embodiment, a non-transitory computer-readable medium includes a computer program to be used in the location estimation device described above.

With a vehicle according to an example embodiment of the present disclosure, an environmental map includes a plurality of partial environmental maps such that, when switching between partial environmental maps during movement, it is possible to perform localization without using an output from an encoder.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating an example configuration of a vehicle according to an example embodiment of the present disclosure.

FIG. 2 is a planar layout diagram schematically illustrating an example of an environment in which the vehicle moves.

FIG. 3 is a diagram illustrating a first partial environmental map M1 and a second partial environmental map M2 of the environment illustrated in FIG. 2.

FIG. 4 is a diagram illustrating an example of a positional relationship between the first partial environmental map M1 and the second partial environmental map M2.

FIG. 5 is a diagram illustrating a relationship between a coordinate system (i.e., an X1Y1 coordinate system) of the first partial environmental map M1 and a coordinate system (i.e., an X2Y2 coordinate system) of the second partial environmental map M2.

FIG. 6A is a diagram illustrating the location and attitude of the vehicle on the first partial environmental map at a time t.

FIG. 6B is a diagram illustrating the location and attitude of the vehicle on the second partial environmental map at the time t and a time t+Δt.

FIG. 7A is a diagram illustrating the first partial environmental map M1.

FIG. 7B is a diagram schematically illustrating an example of scan data SD (t) acquired by an external sensor at the time t.

FIG. 7C is a diagram schematically illustrating a state where matching of the scan data SD (t) against the first partial environmental map M1 has been completed.

FIG. 8A is a diagram schematically illustrating how a point cloud included in scan data is rotated and translated from an initial location and thus brought close to a point cloud on an environmental map.

FIG. 8B is a diagram illustrating the location and attitude after rigid transformation of scan data.

FIG. 9 is a diagram illustrating the first partial environmental map on which the vehicle at the time t is indicated.

FIG. 10A is a diagram illustrating the location and attitude of a vehicle 10 on the second partial environmental map M2 at the time t.

FIG. 10B is a diagram illustrating the location and attitude of the vehicle 10 on the second partial environmental map M2 at the time t+Δt.

FIG. 11 is a diagram schematically illustrating an example of scan data SD (t+Δt) acquired from the external sensor at the time t+Δt.

FIG. 12A is a diagram illustrating relatively large positional gaps between a point cloud in the scan data SD (t+ΔAt) and a point cloud on the second partial environmental map M2.

FIG. 12B is a diagram illustrating relatively small positional gaps between the point cloud in the scan data SD (t +At) and the point cloud on the second partial environmental map M2.

FIG. 13 is a plan view schematically illustrating the locations and attitudes of the vehicle 10 at a time t−Δs, the time t, and the time t+Δt.

FIG. 14 is a flow chart illustrating a part of the operation to be performed by a location estimation device according to an example embodiment of the present disclosure.

FIG. 15 is a flow chart illustrating a part of the operation to be performed by the location estimation device according to an example embodiment of the present disclosure.

FIG. 16 is a flow chart illustrating a part of the operation to be performed by the location estimation device according to an example embodiment of the present disclosure.

FIG. 17 is a diagram illustrating another example configuration of a vehicle according to the present disclosure.

FIG. 18 is a diagram schematically illustrating a vehicle control system including vehicles according to an example embodiment of the present disclosure.

FIG. 19 is a perspective view illustrating an example of an environment in which AGVs are present.

FIG. 20 is a perspective view illustrating an AGV and a trailer unit before being coupled to each other.

FIG. 21 is a perspective view illustrating the AGV and the trailer unit coupled to each other.

FIG. 22 is an external view of an illustrative AGV according to an example embodiment of the present disclosure.

FIG. 23A is a diagram illustrating a first example hardware configuration of the AGV.

FIG. 23B is a diagram illustrating a second example hardware configuration of the AGV.

FIG. 24 is a diagram illustrating an example hardware configuration of an operation management device.

### DETAILED DESCRIPTION

Terminology

The term “automated guided vehicle” refers to an unguided vehicle that has cargo loaded on its body manually or automatically, performs automated travel to a designated place, and then has the cargo unloaded manually or automatically. The term “automated guided vehicle” encompasses an unmanned tractor unit and an unmanned forklift.

The term “unmanned” refers to the absence of need for a person to steer a vehicle, and does not preclude an automated guided vehicle from carrying a “person (who loads/unloads cargo, for example)”.

The term “unmanned tractor unit” refers to an unguided vehicle that performs automated travel to a designated place while towing a car on which cargo is loaded manually or automatically and from which cargo is unloaded manually or automatically.

The term “unmanned forklift” refers to an unguided vehicle that includes a mast for raising and lowering, for example, a fork for cargo transfer, automatically transfers cargo on, for example, the fork, and performs automated travel to a designated place so as to perform an automatic cargo-handling operation.

The term “unguided vehicle” refers to a vehicle including a wheel and an electric motor or an engine to rotate the wheel.

The term “vehicle” refers to a device that moves, while carrying a person or cargo on board, the device including a driving unit (such as a wheel, a two-legged or multi-legged walking device, or a propeller) to produce a traction for movement. The term “vehicle” according to the present disclosure encompasses not only an automated guided vehicle in a strict sense but also a mobile robot, a service robot, and a drone.

The term “automated travel” encompasses travel based on a command from an operation management system of a computer to which an automated guided vehicle is connected via communications, and autonomous travel effected by a controller included in an automated guided vehicle. The term “autonomous travel” encompasses not only travel of an automated guided vehicle to a destination along a predetermined path but also travel that follows a tracking target. An automated guided vehicle may temporarily perform manual travel that is based on an instruction from an operator. The term “automated travel” usually refers to both of travel in a “guided mode” and travel in a “guideless mode”. In the present disclosure, however, the term “automated travel” refers to travel in a “guideless mode”.

The term “guided mode” refers to a mode that involves placing guiding objects continuously or continually, and guiding an automated guided vehicle by using the guiding objects.

The term “guideless mode” refers to a mode that involves guiding without placing any guiding objects. The automated guided vehicle according to an example embodiment of the present disclosure includes a location estimation device and is thus able to travel in a guideless mode.

The term “location estimation device” refers to a device to estimate a location of the device itself on an environmental map in accordance with sensor data acquired by an external sensor, such as a laser range finder.

The term “external sensor” refers to a sensor to sense an external state of a vehicle. Examples of such an external sensor include a laser range finder, a camera (or an image sensor), light detection and ranging (LIDAR), a millimeter wave sensor, an ultrasonic sensor, and a magnetic sensor.

The term “internal sensor” refers to a sensor to sense an internal state of a vehicle. Examples of such an internal sensor include a rotary encoder (which may hereinafter be simply referred to as an “encoder”), an acceleration sensor, and an angular acceleration sensor (e.g., a gyroscope sensor).

The term “SLAM” is an abbreviation for Simultaneous Localization and Mapping and refers to simultaneously carrying out localization and generation of an environmental map.

Basic Configuration of Vehicle according to Present Disclosure

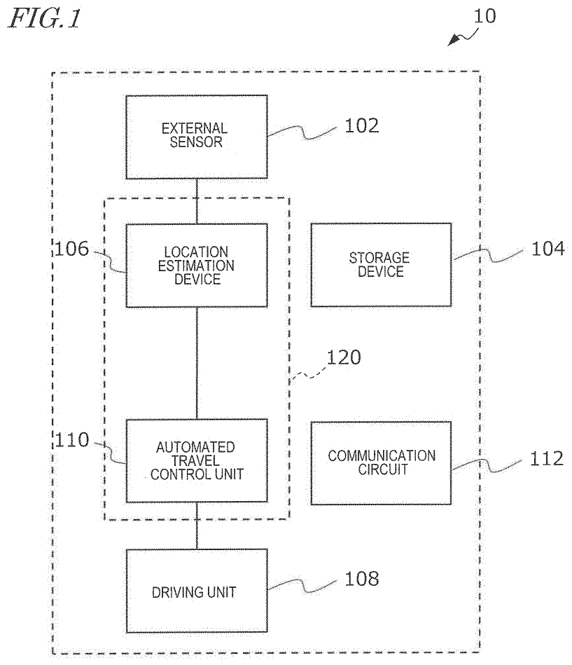

See FIG. 1. In an illustrative example embodiment illustrated in FIG. 1, a vehicle 10 according to the present disclosure includes an external sensor 102 to scan an environment so as to periodically output scan data. A typical example of the external sensor 102 is a laser range finder (LRF). The LRF periodically emits, for example, an infrared or visible laser beam to its surroundings so as to scan the surrounding environment. The laser beam is reflected off, for example, a surface of a structure, such as a wall or a pillar, or an object placed on a floor. Upon receiving reflected light of the laser beam, the LRF calculates a distance to each point of reflection and outputs data on a result of measurement indicative of the location of each point of reflection. The location of each point of reflection is reflective of a direction in which the reflected light comes and a distance that is travelled by the reflected light. The data on the result of measurement (i.e., scan data) may be referred to as “environmental measurement data” or “sensor data”.

The external sensor 102 performs environmental scanning, for example, on an environment in the range of 135 degrees to the right and to the left (which is 270 degrees in total) with respect to the front surface of the external sensor 102. Specifically, the external sensor 102 emits pulsed laser beams while changing the direction of each laser beam for each predetermined step angle within a horizontal plane, and then detects reflected light of each laser beam so as to measure a distance. A step angle of 0.3 degrees allows to obtain measurement data on a distance to a point of reflection in a direction determined by an angle corresponding to a total of 901 steps. In this example, the external sensor 102 scans its surrounding space in a direction substantially parallel to the floor surface, which means that the external sensor 102 performs planar (or two-dimensional) scanning. The external sensor, however, may perform three-dimensional scanning.

A typical example of scan data may be expressed by position coordinates of each point included in a point cloud acquired for each round of scanning. The position coordinates of each point are defined by a local coordinate system that moves together with the vehicle 10. Such a local coordinate system may be referred to as a “vehicle coordinate system” or a “sensor coordinate system”. In the present disclosure, the origin point of the local coordinate system fixed to the vehicle 10 is defined as the “location” of the vehicle 10, and the orientation of the local coordinate system is defined as the “attitude” of the vehicle 10. The location and attitude may hereinafter be collectively referred to as a “pose”.

When represented by a polar coordinate system, scan data may include a numerical value set that indicates the location of each point by the “direction” and “distance” from the origin point of the local coordinate system. An indication based on a polar coordinate system may be converted into an indication based on an orthogonal coordinate system. The following description assumes that scan data output from the external sensor is represented by an orthogonal coordinate system, for the sake of simplicity.

The vehicle 10 includes a storage device 104 to store a plurality of partial environmental maps, and a location estimation device (or localization device) 106. The partial environmental maps include a first partial environmental map and a second partial environmental map linked to each other based on a coordinate transformation relationship. The partial environmental maps may include any other partial environmental map(s) directly or indirectly linked to the first partial environmental map and the second partial environmental map.

The location estimation device 106 matches the scan data acquired from the external sensor 102 against one of the partial environmental maps read from the storage device 104 so as to estimate the location and attitude (i.e., the pose) of the vehicle 10. This matching may be referred to as “pattern matching” or “scan matching” and may be executed in accordance with various algorithms. A typical example of a matching algorithm is an iterative closest point (ICP) algorithm.

In the illustrated example, the vehicle 10 further includes a driving unit 108, an automated travel control unit 110, and a communication circuit 112. The driving unit 108 is a unit to generate a traction necessary for the vehicle 10 to move. Examples of the driving unit 108 include a wheel (or a driving wheel) to be rotated by an electric motor or an engine, and a two-legged or multi-legged walking device to be actuated by a motor or other actuator. The wheel may be an omnidirectional wheel, such as a Mecanum wheel. The vehicle 10 may be a vehicle that moves in the air or water, or a hovercraft. The driving unit 108 in this case includes a propeller to be rotated by a motor.

The automated travel control unit 110 operates the driving unit 108 so as to control conditions (such as velocity, acceleration, and the direction of movement) for movement of the vehicle 10. The automated travel control unit 110 may move the vehicle 10 along a predetermined traveling path, or move the vehicle 10 in accordance with a command provided from outside. When the vehicle 10 is in motion or at rest, the location estimation device 106 calculates an estimated value of the location and attitude of the vehicle 10. The automated travel control unit 110 controls the travel of the vehicle 10 by referring to the estimated value.

The location estimation device 106 and the automated travel control unit 110 may be collectively referred to as a “travel control unit 120”. The travel control unit 120 may include a processor and a memory storing a computer program to control the operation of the processor. The processor and memory just mentioned may be implemented by one or more semiconductor integrated circuits.

The communication circuit 112 is a circuit through which the vehicle 10 is connected to an external management device, another vehicle(s), or a communication network (which includes, for example, a mobile terminal of an operator) so as to exchange data and/or commands therewith.

### Environmental Map

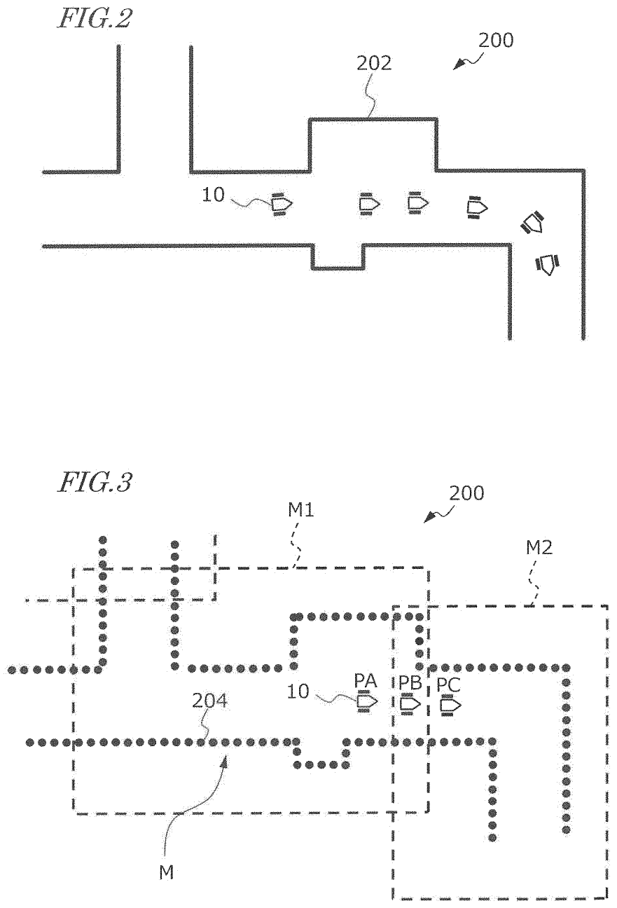

FIG. 2 is a planar layout diagram schematically illustrating an example of an environment 200 in which the vehicle 10 moves. The thick straight lines in FIG. 2 indicate, for example, a fixed wall 202 of a building. The environment 200 is part of a wider environment.

FIG. 3 is a diagram illustrating a first partial environmental map M1 and a second partial environmental map M2 included in a map (i.e., an environmental map M) of the environment 200 illustrated in FIG. 2. The environmental map M may include any other partial environmental map(s) besides the first partial environmental map M1 and the second partial environmental map M2. Each dot 204 in FIG. 3 is equivalent to an associated point in a point cloud included in the environmental map M. In the present disclosure, the point cloud in the environmental map M may be referred to as a “reference point cloud”, and a point cloud in scan data may be referred to as a “data point cloud” or a “source point cloud”. Matching involves, for example, effecting positioning of scan data (or data point cloud) with respect to a partial environmental map (or reference point cloud) whose location is fixed. Specifically, matching to be performed using an ICP algorithm involves selecting pairs of corresponding points included in a reference point cloud and a data point cloud, and adjusting the location and orientation of the data point cloud so that a distance (or error) between the points of each pair is minimized.

In FIG. 3, the dots 204 are arranged at equal intervals on a plurality of line segments, for the sake of simplicity. In reality, the point cloud in the environmental map M may have a more complicated arrangement pattern. The environmental map M is not limited to a point cloud map but may be a map including a straight line(s) or a curve(s), or an occupancy grid map. That is, the environmental map M preferably has a structure that enables scan data and the environmental map M to be matched against each other.

When the vehicle 10 is at a location PA illustrated in FIG. 3, scan data acquired at the location PA by the external sensor is matched against the first partial environmental map M1. As a result, estimated values of the location and attitude of the vehicle 10 are obtained. The location and attitude of the vehicle 10 are expressed by the coordinate system of the first partial environmental map M1. When the vehicle 10 has passed through a location PB and moved to a location PC, scan data acquired at the location PC by the external sensor is matched against the second partial environmental map M2. As a result, estimated values of the location and attitude of the vehicle 10 are obtained. The location and attitude of the vehicle 10 in this case are expressed not by the coordinate system of the first partial environmental map M1 but by the coordinate system of the second partial environmental map M2. The “values” of the location and attitude of the vehicle 10 may thus be expressed by the coordinate system of a partial environmental map that is selected in accordance with the location of the vehicle 10. The location PB is situated within a region where the first partial environmental map M1 and the second partial environmental map M2 overlap with each other. Accordingly, when the vehicle 10 is at the location PB in FIG. 3, the location and attitude of the vehicle 10 may have both of: values based on the coordinate system of the first partial environmental map M1; and values based on the coordinate system of the second partial environmental map M2.

If the vehicle 10 is not located within the region where the first partial environmental map M1 and the second partial environmental map M2 overlap with each other, values of one of the coordinate systems can be converted into values of the other coordinate system as long as the relationship between the coordinate system of the first partial environmental map M1 and the coordinate system of the second partial environmental map M2 is known.

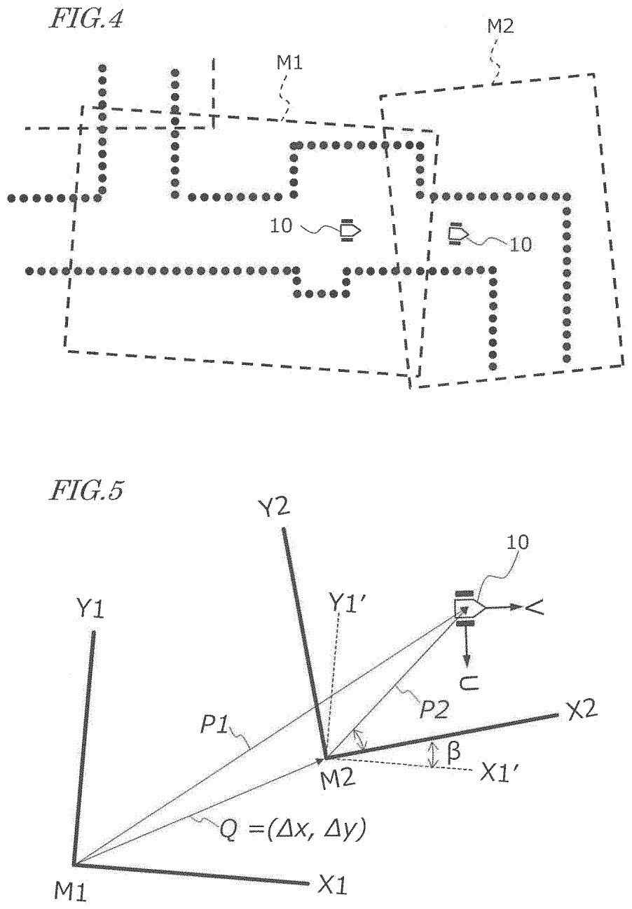

As illustrated in FIG. 4, partial environmental maps, including the first partial environmental map M1 and the second partial environmental map M2, are not necessarily arranged in parallel with each other. In such a case, conversion between the coordinate system of the first partial environmental map M1 and the coordinate system of the second partial environmental map M2 requires not only a simple translational movement but also a rotational movement.

FIG. 5 is a diagram schematically illustrating a relationship between the coordinate system (i.e., an X1Y1 coordinate system) of the first partial environmental map M1 and the coordinate system (i.e., an X2Y2 coordinate system) of the second partial environmental map M2. In the example illustrated in FIG. 5, the location of the vehicle 10 has a value P1=(x1, y1) in the X1Y1 coordinate system and a value P2=(x2, y2) in the X2Y2 coordinate system. The attitude (or orientation) of the vehicle 10 has a value θ1 in the X1Y1 coordinate system and a value θ2 in the X2Y2 coordinate system. In this example, θ2−θ1=β. The X2Y2 coordinate system is a coordinate system obtained by rotating the X1Y1 coordinate system counterclockwise by an angle β and translating the X1Y1 coordinate system by Q=(Δx, Δy).

FIG. 5 also illustrates a UV coordinate system that is a local coordinate system (or sensor coordinate system) of the vehicle 10. Scan data is expressed by the UV coordinate system. The location of the vehicle 10 on an i-th partial environmental map (where i is an integer equal to or greater than 1) Mi is indicated by coordinate values (xi, yi) of the origin point of the UV coordinate system for a coordinate system Mi of the i-th partial environmental map Mi. The attitude (or orientation) of the vehicle 10 is an orientation (θi) of the UV coordinate system for the coordinate system Mi of the i-th partial environmental map Mi. θi is “positive” in a counterclockwise direction.

When the status of the vehicle 10 in the X1Y1 coordinate system is represented as ¹p=(x1, y1, θ1, 1) and the status of the vehicle 10 in the X2Y2 coordinate system is represented as ²p=(x2, y2, θ2, 1), the following relationship is established:

$$[ \begin{matrix}x 1 \\ y 1 \\ θ1 \\ 1\end{matrix} ] = {[ \begin{matrix}cos ( β ) & - sin ( β ) & 0 & Δ x \\ sin ( β ) & cos ( β ) & 0 & Δ y \\ 0 & 0 & 1 & - β \\ 0 & 0 & 0 & 1\end{matrix} ]}^{- 1} [ \begin{matrix}x 2 \\ y 2 \\ θ2 \\ 1\end{matrix} ] \qquad [ Eq . 1 ]$$

The transformation matrix on the right side of Eq. 1 is representable as ¹T₂ as indicated by Eq. 2 below. Eq. 1 is thus simply represented by Eq. 3 below.

$$\begin{matrix}{}_{}^{1}{T}{}_{2}^{} = [ \begin{matrix}cos ( β ) & - sin ( β ) & 0 & Δ x \\ sin ( β ) & cos ( β ) & 0 & Δ y \\ 0 & 0 & 1 & - β \\ 0 & 0 & 0 & 1\end{matrix} ] & [ Eq . 2 ] \\ {}^{1} P = {}_{}^{1}{T}{}_{2}^{} {}^{2} P & [ Eq . 3 ]\end{matrix}$$

Eq. 4 is derived from Eq. 1.

$$[ \begin{matrix}x 2 \\ y 2 \\ θ2 \\ 1\end{matrix} ] = {[ \begin{matrix}cos ( β ) & - sin ( β ) & 0 & Δ x \\ sin ( β ) & cos ( β ) & 0 & Δ y \\ 0 & 0 & 1 & - β \\ 0 & 0 & 0 & 1\end{matrix} ]}^{- 1} [ \begin{matrix}x 1 \\ y 1 \\ θ1 \\ 1\end{matrix} ] \qquad [ Eq . 4 ]$$

When the inverse matrix of ¹T₂ is represented as ²T₁ as indicated by Eq. 5 below, Eq. 6 is obtained.

¹T₂⁻¹=²T₁ [Eq. 5]

²P=²T₋₁ ¹P [Eq. 6]

The aforementioned relational expressions Eq. 1 and Eq. 4 define the relationship between the first partial environmental map M1 and the second partial environmental map M2. Defining this relationship enables mutual conversion between (x1, y1, θ1) indicative of the location and attitude of the vehicle 10 in the X1Y1 coordinate system and (x2, y2, θ2) indicative of the location and attitude of the vehicle 10 in the X2Y2 coordinate system. In the present disclosure, when the positional relationship between the coordinate system of a partial environmental map and the coordinate system of another partial environmental map is known, the following definition is given: These “partial environmental maps are linked”.

In the example embodiment of the present disclosure, the first partial environmental map M1 and the second partial environmental map M2 are linked. Thus, when the vehicle 10 is, for example, at the location PB in FIG. 3, the use of Eq. 4 makes it possible to calculate the location and attitude (x2, y2, θ2) of the vehicle 10 on the second partial environmental map M2 from the location and attitude (x1, y1, θ1) of the vehicle 10 on the first partial environmental map M1.

“Linking” the first partial environmental map M1 and the second partial environmental map M2 preferably involves, in generating the maps, acquiring values for the vehicle 10 (which is at physically the same location and has physically the same attitude within a boundary region between the first partial environmental map M1 and the second partial environmental map M2 or an overlapping region where the first partial environmental map M1 and the second partial environmental map M2 overlap with each other) by using the coordinate system of each of the first partial environmental map M1 and the second partial environmental map M2. Specifically, this process preferably involves causing the location estimation device of the vehicle 10 at this location to execute localization using the first partial environmental map M1 and localization using the second partial environmental map M2 so as to output (x1, y1, θ1) and (x2, y2, θ2). Operations of the location estimation device will be described below. When (x1, y1, θ1) and (x2, y2, θ2) are known, Δx, Δy, and β that are unknowns are calculable from Eq. 1 or Eq. 4. As a result, parameters (Δx, Δy, and β) of the transformation matrix defined by translation and rotation are determined, thus establishing a “link”.

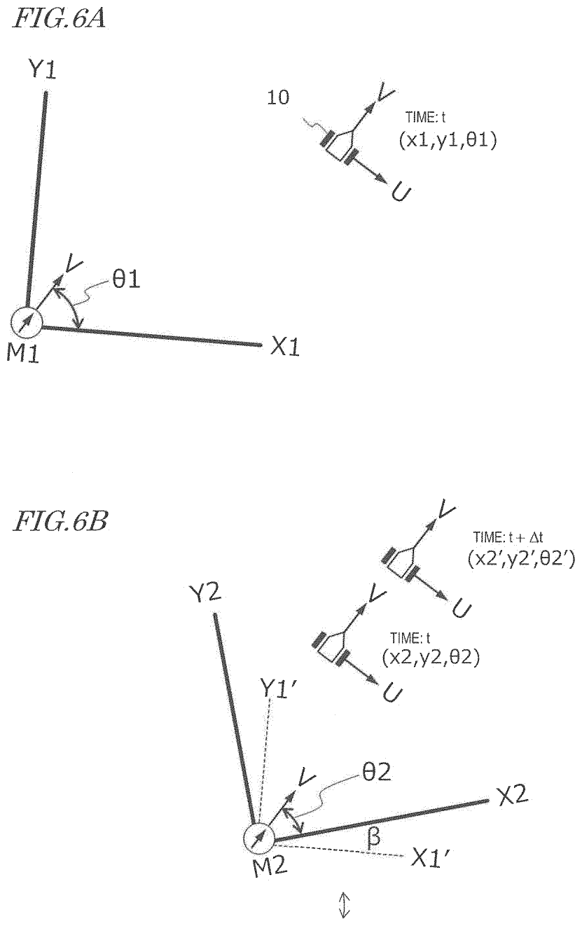

FIG. 6A is a diagram schematically illustrating the location and attitude, i.e., the pose (x1, y1, θ1), of the vehicle 10 at a time t when switching from the first partial environmental map M1 to the second partial environmental map M2, which are linked together, occurs. FIG. 6A illustrates the X1Y1 coordinate system of the first partial environmental map M1. FIG. 6B is a diagram schematically illustrating the location and attitude (x2, y2, θ2) of the vehicle 10 at the time t and the location and attitude (x2′, y2′, θ2′) of the vehicle 10 at a time t+Δt. FIG. 6B illustrates the X2Y2 coordinate system of the second partial environmental map M2.

When switching from the first partial environmental map M1 to the second partial environmental map M2 at the time t, a period of time Δt, for example, is required to read the second partial environmental map M2 from the storage device 104 (FIG. 1) so as to start matching. The location and attitude of the vehicle 10 thus change from (x2, y2, θ2) to (x2′, y2′, θ2′) during the period of time Δt.

For example, in the case where an encoder is attached to a driving wheel of the vehicle 10, it is possible to acquire variations in the location and attitude of the vehicle 10 (Δx2, Δy2, Δθ2)=(x2′−x2, y2′−y2, θ2′−θ2) through measurement. When matching as described below is performed, values resulting from corrections made to (x2, y2, θ2) in accordance with outputs from the encoder, i.e., values (x2′, y2′, θ2′), can be used as initial values.

In the example embodiment of the present disclosure, however, a matching after switching between the partial environmental maps is performed without using an output from an internal sensor, such as an encoder. Detailed description will be made below in this respect.

### Matching

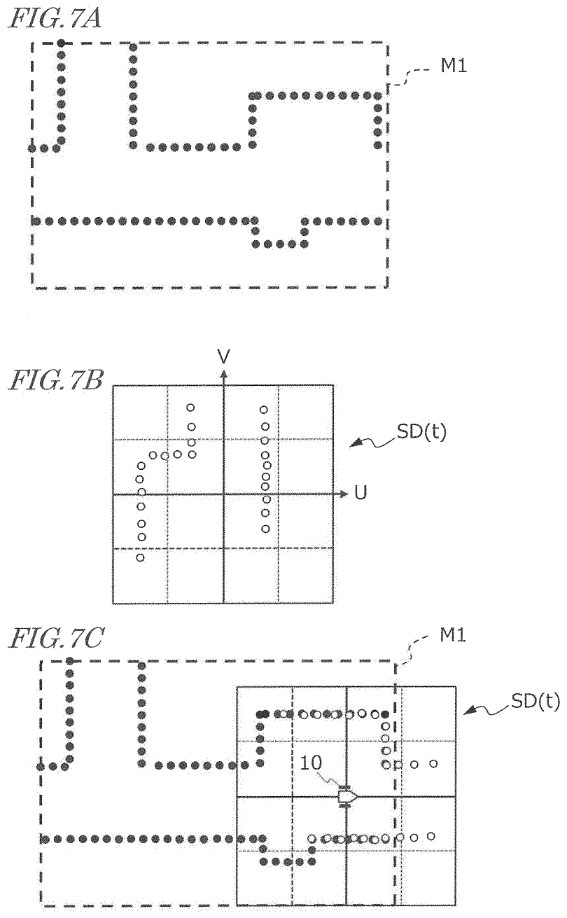

FIG. 7A is a diagram illustrating the first partial environmental map M1. FIG. 7B is a diagram schematically illustrating an example of scan data SD (t) acquired by an external sensor at the time t. The scan data SD (t) in FIG. 7B is presented by the sensor coordinate system whose location and attitude change together with the vehicle 10. For the sake of clarity, points included in the scan data SD (t) are provided in the form of open circles. The scan data SD (t) is represented by a UV coordinate system (see FIG. 5) whose V axis is directly to the front of the external sensor 102 and whose U axis extends in a direction rotated from the V axis by 90 degrees clockwise. The vehicle 10 (or more precisely, the external sensor 102) is located at the origin point of the UV coordinate system. In the present disclosure, the vehicle 10 travels in a direction right in front of the external sensor 102 (i.e., along the V axis) during forward travel of the vehicle 10.

FIG. 7C is a diagram schematically illustrating a state where matching of the scan data SD (t) against the first partial environmental map M1 has been completed. In the state where matching has been completed, a relationship is established between the location and attitude of the sensor coordinate system at the time when the external sensor 102 has acquired the scan data SD (t) and the location and attitude of the coordinate system of the first partial environmental map M1. This determines estimated values of the location (i.e., the origin point of the sensor coordinate system) and attitude (i.e., the orientation of the sensor coordinate system) of the vehicle 10 at the time t (location identification).

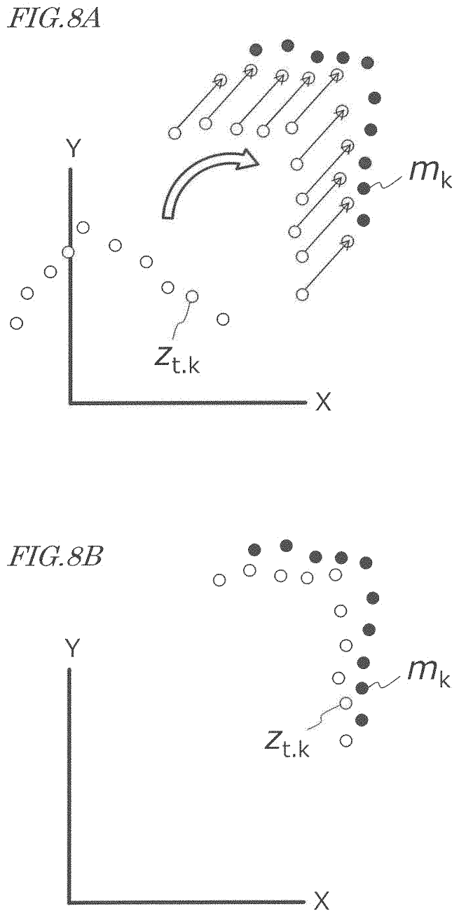

FIG. 8A is a diagram schematically illustrating how a point cloud included in scan data is rotated and translated from an initial location and thus brought close to a point cloud on an environmental map. The coordinate value of a k-th point of K points (where k=1, 2, . . . , K−1, K) included in the point cloud of the scan data at the time t is represented as Z_{t,k}, and the coordinate value of a point on the environmental map corresponding to the k-th point is represented as mₖ. In this case, errors between the corresponding points in the two point clouds can be evaluated using, as a cost function, Σ(Z_{t,k}−mₖ)² that is a square sum of errors calculated for K corresponding points. Rotational and translational rigid transformation is determined so that Σ(Z_{t,k}−mₖ)² decreases. Rigid transformation is defined by a transformation matrix (e.g., a homogeneous transformation matrix) including a rotation angle and a translation vector as parameters.

FIG. 8B is a diagram illustrating the location and attitude after rigid transformation of the scan data. In the example illustrated in FIG. 8B, the process of matching the scan data against the environmental map has not been completed, so that large errors (or positional gaps) still exist between the two point clouds. To reduce the positional gaps, rigid transformation is further carried out. When the errors thus fall below a predetermined value, matching is completed.

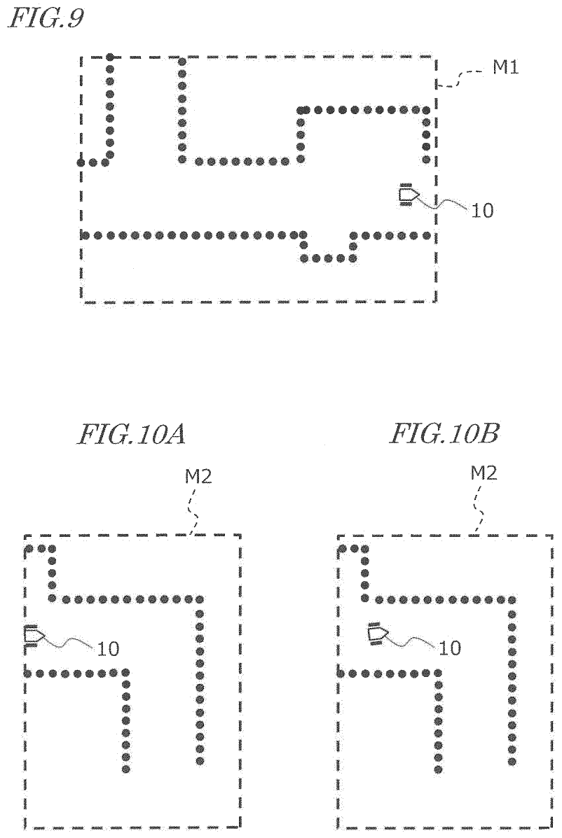

FIG. 9 is a diagram illustrating the first partial environmental map that indicates an estimated location and an estimated attitude of the vehicle 10 at the time t as obtained through matching.

FIG. 10A is a diagram illustrating the location and attitude of the vehicle 10 on the second partial environmental map M2 at the time t. FIG. 10B is a diagram illustrating the location and attitude of the vehicle 10 on the second partial environmental map M2 at the time t+Δt. The process of reading the second partial environmental map M2 has not yet been finished at the time t. Matching for the second partial environmental map M2 is allowed to start at the time t+Δt.

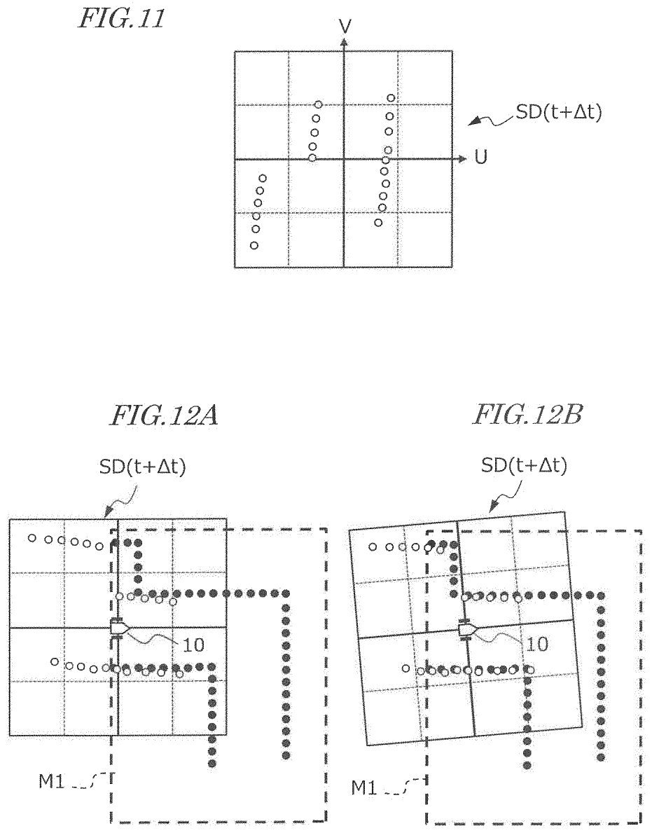

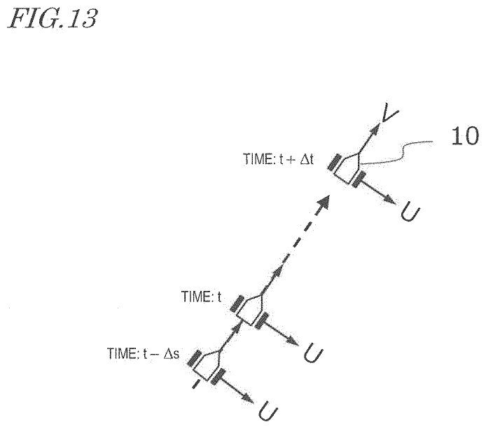

FIG. 11 is a diagram schematically illustrating an example of the scan data SD (t+Δt) acquired from the external sensor at the time t+Δt. When the scan data SD is matched against the second partial environmental map M2, the use of the location and attitude of the vehicle 10 illustrated in FIG. 10A as initial values of the vehicle 10 increases the positional gaps between the point cloud of the scan data SD (t+Δt) and the point cloud of the second partial environmental map M2 as illustrated in FIG. 12A. This may raise the possibility of increasing the amount of time required for matching or preventing completion of matching within a predetermined period of time, resulting in a failure in location identification. Such a possibility may make it necessary to stop or decelerate the vehicle at the time of switching between the partial environmental maps. The use of the location and attitude illustrated in FIG. 10B as initial values of the vehicle 10, however, reduces the positional gaps between the point cloud of the scan data SD (t+Δt) and the point cloud of the second partial environmental map M2 as illustrated in FIG. 12B. This results in not only a reduction in the amount of time required for matching but also an increase in the reliability of matching.

The above-described problems associated with movement of the vehicle 10 at the time of switching between the partial environmental maps have conventionally been solved by measuring a moving amount of the vehicle 10 in accordance with an output from an internal sensor, such as an encoder. In example embodiments of the present disclosure, however, these problems are solved by a method described below, i.e., without measuring a moving amount of the vehicle 10 by an internal sensor.

First, the time at which switching between the partial environmental maps starts is represented as t, and the amount of time required for switching between the partial environmental maps is represented as Δt. The time at which the latest estimated values of the location and attitude of the vehicle 10 before switching between the partial environmental maps are output is represented as t−Δs. Specifically, the estimated values of the location and attitude of the vehicle 10 may be output periodically (e.g., for every 20 to 40 milliseconds). In this example, Δs is, for example, 25 milliseconds.

FIG. 13 is a plan view schematically illustrating the locations of the vehicle 10 at the time t−Δs, the time t, and the time t+Δt. A rate of change in the location and attitude of the vehicle 10 during the time Δs is calculated from an estimated value (i.e., an output value) of the location of the vehicle 10 at the time t−Δs and an estimated value (i.e., an output value) of the location of the vehicle 10 at the time t. Using the rate of change makes it possible to determine a predicted value of the location of the vehicle 10 at the time t+Δt. The rate of change in the location (i.e., a moving velocity) may be determined by referring to a plurality of locations in the past (such as the locations at a time t−2×Δs and a time t−3×Δs) instead of or in addition to the location at the time t−Δs.

The time Δt required for switching between the partial environmental maps is about 50 milliseconds. Usually Δt is longer than Δs. It is assumed herein that the attitude (or orientation) of the vehicle 10 hardly changes at a place where switching between the partial environmental maps is performed. A change in the attitude during the time Δt is thus negligible. A change in the attitude of the vehicle 10 at a place where switching between the partial environmental maps is performed, however, may be taken into consideration. In this case, the attitude at the time t+Δt is predictable in accordance with estimated values of attitudes acquired at a plurality of locations in the past.

It should be noted that the “rate of change in the location (i.e., a moving velocity)” of the vehicle 10 during the time Δs is a vector, and thus depends on the coordinate system of the map to be used. Accordingly, the “rate of change in the location” calculated in accordance with the first partial environmental map M1 is converted into a “rate of change in the location” in the coordinate system of the second partial environmental map M2 by performing a coordinate transformation that defines the linking relationship mentioned above. Specifically, the moving velocity of the vehicle 10 on the first partial environmental map M1 is determined in accordance with a history of estimated locations and estimated attitudes of the vehicle 10 on the first partial environmental map M1, and then the location and attitude of the vehicle 10 on the second partial environmental map M2 are predictable in accordance with the moving velocity.

Refer again to FIGS. 6A and 6B. First, the corresponding location and corresponding attitude (x2, y2, θ2) on the coordinate system of the second partial environmental map M2 at the time t, corresponding to the location and attitude (x1, y1, θ1) on the coordinate system of the first partial environmental map M1 at the time t, are calculated by using a transformation matrix. In other words, the corresponding location and corresponding attitude on the second partial environmental map M2 are determined based on a coordinate transformation relationship. Then, values (x2, y2, θ2) of the location and attitude on the second partial environmental map M2 at the time t are corrected to values (x2′, y2′, θ2′) of the location and attitude on the second partial environmental map M2 at the time t+Δt in accordance with the “rate of change in the location”. In this case, the approximate expression θ2′=θ2 is used.

As described above, in an example embodiment of the present disclosure, for the estimated location and estimated attitude of the vehicle 10 on the first partial environmental map M1, the corresponding location and corresponding attitude on the second partial environmental map M2 are calculated in accordance with the linking relationship for the partial environmental maps first. Then, the corresponding location and corresponding attitude are corrected in accordance with the history of estimated locations and estimated attitudes of the vehicle 10 on the first partial environmental map M1. The time Δt required for the correcting calculation is determined depending on the point of timing (i.e., the time t+Δ) when matching for estimating the location and attitude of the vehicle 10 on the second partial environmental map M2 starts. Using, as initial values, the corresponding location and corresponding attitude thus corrected, matching for estimating the location and attitude of the vehicle 10 on the second partial environmental map M2 is performed.

The method for determining predicted values of the location and attitude of the vehicle 10 at the time t+Δt from estimated values of the locations and attitudes of the vehicle 10 at the time t−Δs and the time t, which have been acquired by location identification, is not limited to the example described above.

Predicted values of the location and attitude on the coordinate system of the first partial environmental map M1 at the time t+Δt may initially be calculated in accordance with the “rate of change in the location” on the first partial environmental map M1 at the time t−Δs and the time t. Then, the predicted values of the location and attitude on the coordinate system of the first partial environmental map M1 at the time t+Δt may be converted into values on the coordinate system of the second partial environmental map M2 by using a transformation matrix.

Alternatively, estimated values of the locations and attitudes of the vehicle 10 at the time t−Δs and the time t, which have been acquired by location identification, may initially be converted into values on the second partial environmental map M2 by using a transformation matrix. Then, the “rate of change in the location” on the coordinate system of the second partial environmental map M2 may be calculated so as to determine predicted values of the location and attitude of the vehicle 10 at the time t+Δt.

In an example embodiment of the present disclosure, the above method makes it possible to determine the moving velocity of the vehicle 10 on the first partial environmental map M1 in accordance with the history of estimated locations and estimated attitudes of the vehicle 10 on the first partial environmental map M1, and then to predict the location and attitude of the vehicle 10 on the second partial environmental map M1 at the time t+Δt in accordance with the moving velocity. Suitable values are thus acquirable as initial values for matching, which starts at the time t+Δt after map switching, without using an output from an internal sensor.

### Operational Flow of Location Estimation Device

Referring to FIG. 1 and FIGS. 14 to 16, operating steps to be performed by the location estimation device according to an example embodiment of the present disclosure will be described.

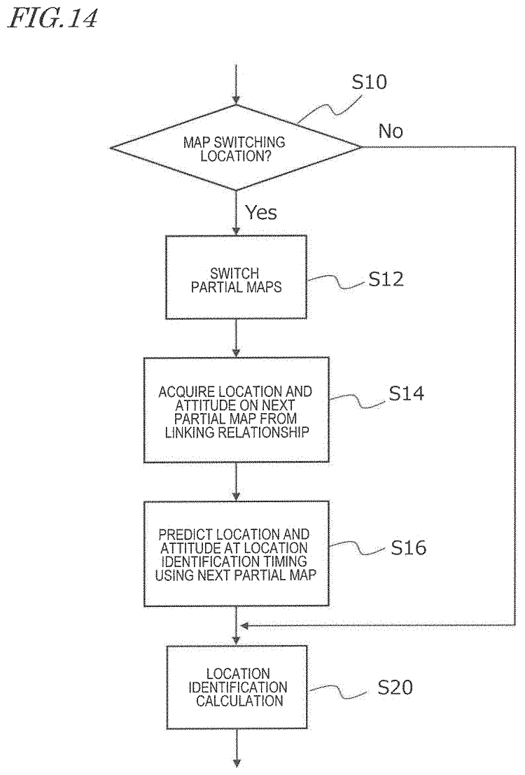

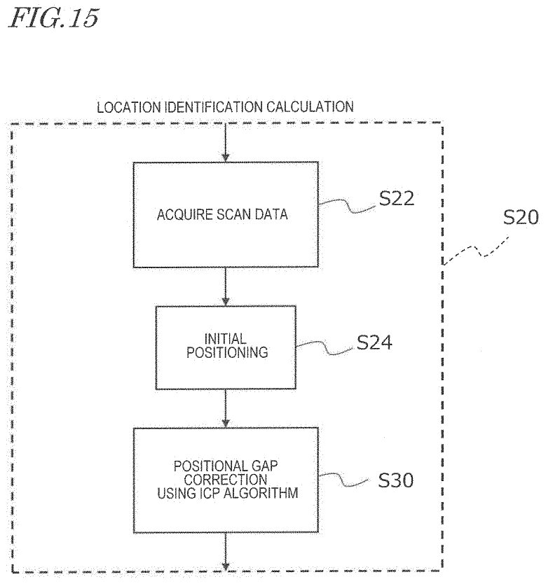

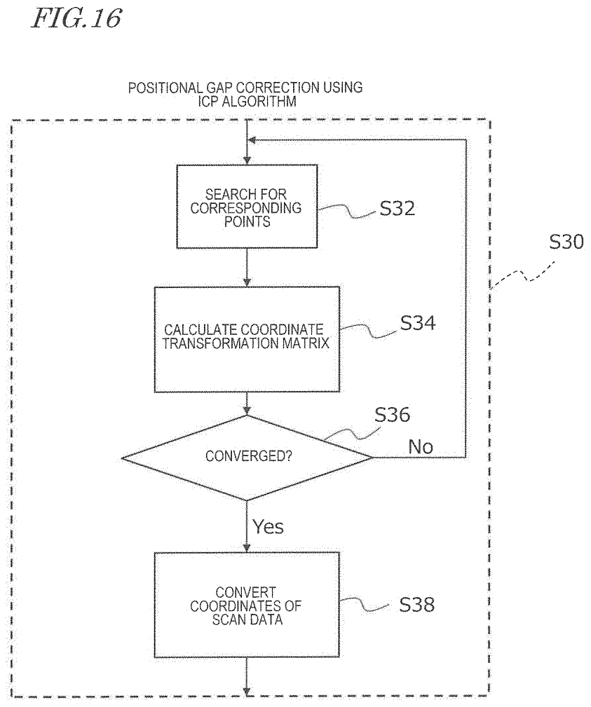

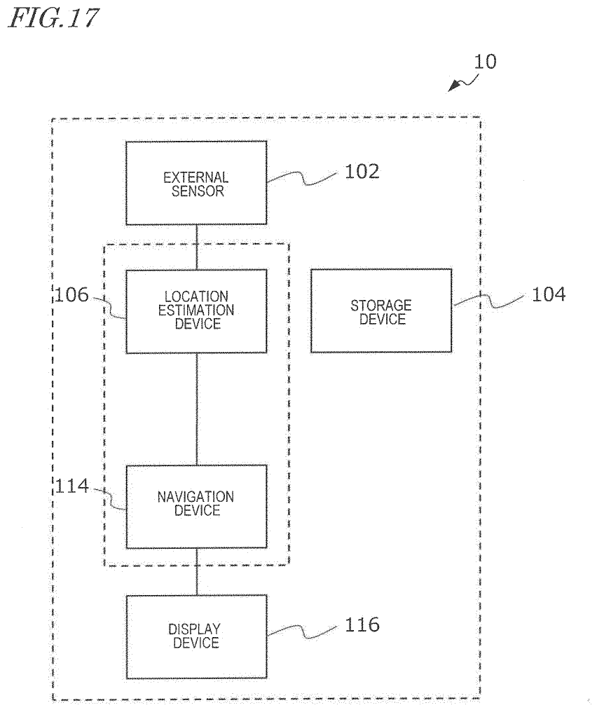

First, FIG. 14 is referred to.

In step S10, the location estimation device 106 determines whether the location of the vehicle 10 is a location at which partial environmental maps are to be switched. When the answer is No, the process goes to step S20. Step S20 will be described below. When the answer is Yes, the process goes to step S12.

In step S12, the location estimation device 106 switches the partial environmental maps. In this step, the location estimation device 106 reads, from the storage device 104 illustrated in FIG. 1, a partial environmental map that is selected in accordance with the location of the vehicle 10. The partial environmental map having been read is stored in a memory (not shown) of the location estimation device 106. In this step, the partial environmental map used before switching does not need to be deleted from the memory. Because the storage capacity of the memory is smaller than the storage capacity of the storage device 104, any unnecessary partial environmental map(s) may be deleted from the memory.

In step S14, from the linking relationship between a next partial environmental map that is newly read from the storage device 104 and the preceding partial environmental map, the location and attitude of the vehicle on the next partial environmental map are calculated and acquired. In this step, the location estimation device 106 executes conversion by using the transformation matrix of Eq. 4.

In step S16, the location estimation device 106 calculates predicted values of the location and attitude of the vehicle at the point of timing when matching on the next partial environmental map starts.

In step S20, the location estimation device 106 starts, immediately after switching between the partial environmental maps, matching by using the predicted values as initial values so as to execute location identification calculation.

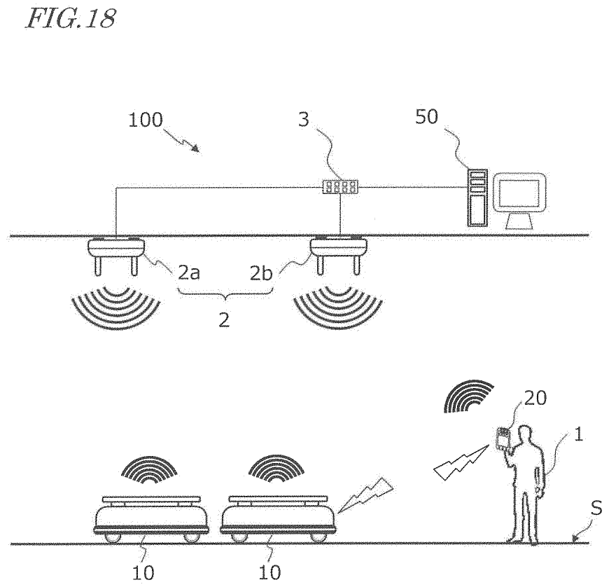

Referring to FIG. 15, the location identification calculation in step S20 will be described below in more detail.

First, in step S22, the location estimation device 106 acquires scan data from the external sensor 102.

In step S24, the location estimation device 106 performs initial positioning by using the predicted values calculated in step S16. When the partial environmental maps are not switched (i.e., when the answer is “No” in step S10), matching may be performed by using, as initial values, the location and attitude at the time t. Alternatively, predicted values of the location and attitude at the time when the latest scan data is acquired may be calculated by the method described with reference to FIG. 13 so as to perform matching by using the predicted values as initial values.

In step S30, the location estimation device 106 according to the present example embodiment makes positional gap correction by using an ICP algorithm.

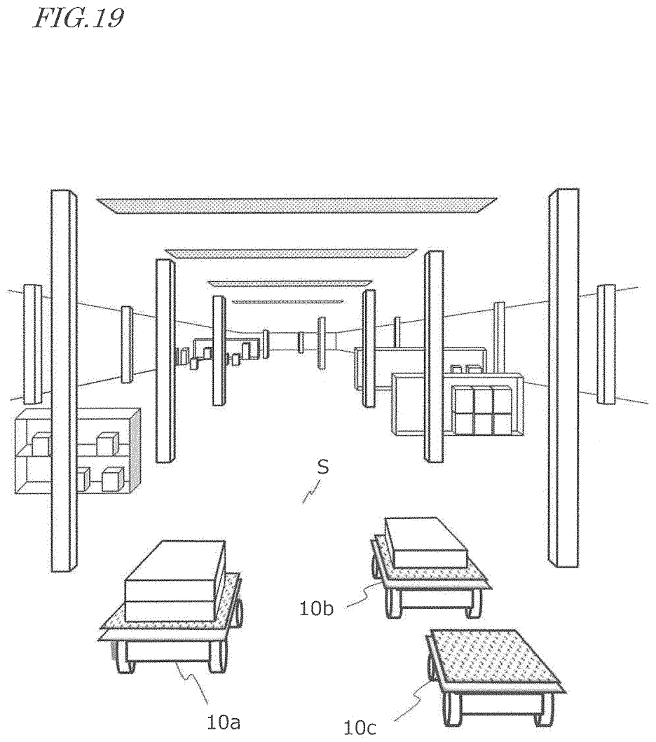

Referring to FIG. 16, positional gap correction made in step S30 will be described below.

First, in step S32, a search is made for corresponding points. Specifically, points on the partial environmental map are selected, each corresponding to an associated one of points of a point cloud included in scan data.

In step S34, rotational and translational rigid transformation (i.e., coordinate transformation) for the scan data is performed so that distances between the corresponding points of the scan data and the partial environmental map are reduced. This is synonymous to optimizing parameters of a coordinate transformation matrix so that a sum total (or square sum) of the distances between the corresponding points (i.e., the errors between the corresponding points) is reduced. This optimization is performed by iterative calculations.

Step S36 involves determining whether the iterative calculations have converged. Specifically, they are determined to have converged when a decrement in the sum total (or square sum) of the errors between the corresponding points remains below a predetermined value even if the parameters of the coordinate transformation matrix are changed. When they have not yet converged, the process returns to step S32 to repeat the process beginning from making a search for corresponding points. When the results of iterative calculations are determined to have converged in step S36, the process goes to step S38.

In step S38, by using the coordinate transformation matrix, coordinate values of the scan data are converted from values of the sensor coordinate system into values of the coordinate system of the partial environmental map.

The vehicle according to the present disclosure reduces the possibility that after switching between the partial environmental maps, the amount of time required for matching significantly may increase or matching may not be completed within a predetermined period of time, thus resulting in a failure in location identification. This makes it unnecessary to stop or decelerate the vehicle at the time of switching between the partial environmental maps.

The vehicle according to the present disclosure also makes it unnecessary to estimate the location and attitude by using an output from an internal sensor, such as a rotary encoder. A rotary encoder, in particular, produces large errors when a wheel slips, resulting in low reliability of measured values because the errors are accumulated. Measurement by a rotary encoder is not suitable for a vehicle that moves by using an omnidirectional wheel (such as a Mecanum wheel) or a two-legged or multi-legged walking device, or flying vehicles (such as a vercraft and a drone). In contrast, the location estimation device according to the present disclosure is usable for various vehicles that move by using various driving units.

The vehicle according to the present disclosure does not need to include a driving unit. The vehicle may be, for example, a handcart to be thrusted by a user. Such a vehicle may present the location or the location and attitude of the vehicle (which has or have been acquired from the location estimation device) on a map on a display device for the user. The vehicle may notify the user of the location or the location and attitude of the vehicle by sound.

FIG. 17 is a diagram illustrating another example configuration of the vehicle 10 according to the present disclosure. The vehicle 10 illustrated in FIG. 17 includes a navigation device 114 to guide the user by using information on the location or the location and attitude of the vehicle output from the location estimation device 106. The navigation device 114 is connected to a display device 116 to guide the user with an image(s) or a sound(s). The display device 116 is able to present the current location and target location on a map or emit a sound such as “stop” or “turn right”. The user is thus able to move the vehicle 10 to its destination by pushing the vehicle 10. Examples of the vehicle 10 just described include a handcart and other carts.

The vehicle 10 configured as illustrated in FIG. 17 provides a route guide in accordance with the destination or path preliminarily stored in a memory (not shown) in the navigation device 114.

### Illustrative Example Embodiment

The example embodiment of the vehicle according to the present disclosure will be described below in more detail. In the present example embodiment, an automated guided vehicle will be used as an example of the vehicle. In the following description, the automated guided vehicle will be abbreviated as “AGV”. The “AGV” will hereinafter be identified by the reference sign “10” similarly to the vehicle 10.

### (1) Basic Configuration of System

FIG. 18 illustrates an example basic configuration of an illustrative vehicle management system 100 according to the present disclosure. The vehicle management system 100 includes at least one AGV 10 and an operation management device 50 to manage operations of the AGV 10. FIG. 18 also illustrates a terminal device 20 to be operated by a user 1.

The vehicle 10 is an automated guided car that is able to travel in a “guideless mode” that requires no guiding object, such as a magnetic tape, for travel. The AGV 10 is able to perform localization and transmit estimation results to the terminal device 20 and the operation management device 50. The AGV 10 is able to perform automated travel in an environment S in accordance with a command from the operation management device 50.

The operation management device 50 is a computer system that tracks the location of each AGV 10 and manages the travel of each AGV 10. The operation management device 50 may be a desktop PC, a notebook PC, and/or a server computer. The operation management device 50 communicates with each AGV 10 through a plurality of access points 2. For example, the operation management device 50 transmits, to each AGV 10, data on the coordinates of the next destination for each AGV 10. Each AGV 10 transmits, to the operation management device 50, data indicative of the location and attitude (or orientation) of each AGV 10 at regular time intervals (e.g., for every 250 milliseconds). When the AGV 10 has reached the designated location, the operation management device 50 transmits data on the coordinates of the next destination to the AGV 10. Each AGV 10 may be able to travel in the environment S in accordance with an operation input to the terminal device 20 by the user 1. An example of the terminal device 20 is a tablet computer.

FIG. 19 illustrates an example of the environment S where three AGVs 10a, 10b, and 10c are present. Each of the AGVs is traveling in a depth direction in FIG. 19. The AGVs 10a and 10b are conveying cargo placed on their tops. The AGV 10c is following the AGV 10b traveling ahead of the AGV 10c. Although the AGVs are identified by the reference signs “10a”, “10b”, and “10c” in FIG. 19 for the sake of convenience of description, they will hereinafter be described as the “AGV 10”.

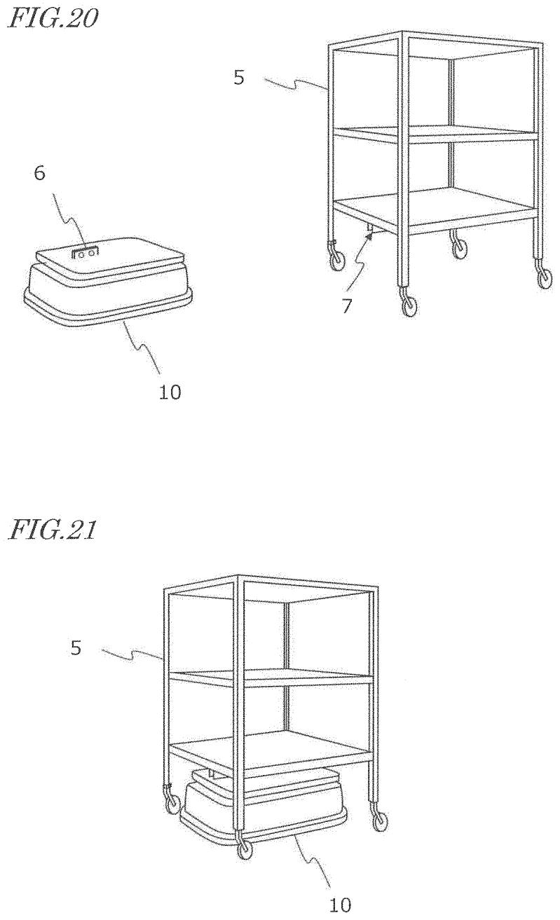

The AGV 10 is able to not only convey cargo placed on its top but also convey cargo by using a trailer unit connected to the AGV 10. FIG. 20 illustrates the AGV 10 and a trailer unit 5 before being coupled to each other. Each leg of the trailer unit 5 is provided with a caster. The AGV 10 is mechanically coupled to the trailer unit 5. FIG. 21 illustrates the AGV 10 and the trailer unit 5 coupled to each other. When the AGV 10 travels, the trailer unit 5 is towed by the AGV 10. The AGV 10 is able to convey the cargo placed on the trailer unit 5 by towing the trailer unit 5.

The AGV 10 may be coupled to the trailer unit 5 by any method. An example of the coupling method will be described below. A plate 6 is secured to the top of the AGV 10. The trailer unit 5 is provided with a guide 7 including a slit. The AGV 10 approaches the trailer unit 5 so that the plate 6 is inserted into the slit of the guide 7. Upon completion of the insertion, the AGV 10 has an electromagnetic lock pin (not shown) passed through the plate 6 and the guide 7 and activates an electromagnetic lock. The AGV 10 and the trailer unit 5 are thus physically coupled to each other.

Refer again to FIG. 18. Each AGV 10 and the terminal device 20 are connected to each other, for example, on a one-to-one basis so that each AGV 10 and the terminal device 20 are able to mutually communicate in compliance with Bluetooth (registered trademark) standards. Each AGV 10 and the terminal device 20 may mutually communicate in compliance with Wi-Fi (registered trademark) standards by using one or more of the access points 2. The access points 2 are mutually connected through, for example, a switching hub 3. In FIG. 18, two access points 2a and 2b are illustrated. Each AGV 10 is wirelessly connected to the access point 2a. The terminal device 20 is wirelessly connected to the access point 2b. Data transmitted from each AGV 10 is received by the access point 2a, transferred to the access point 2b through the switching hub 3, and then transmitted from the access point 2b to the terminal device 20. Data transmitted from the terminal device 20 is received by the access point 2b, transferred to the access point 2a through the switching hub 3, and then transmitted from the access point 2a to each AGV 10. This enables two-way communication between each AGV 10 and the terminal device 20. The access points 2 are also connected to the operation management device 50 through the switching hub 3. This enables two-way communication between the operation management device 50 and each AGV 10.

### (2) Creation of Environmental Map

A map of the environment S is generated so that each AGV 10 is able to travel while estimating its own location. Each AGV 10 is equipped with a location estimation device and an LRF and is thus able to generate a map by using an output from the LRF.

Each AGV 10 shifts to a data acquisition mode in response to an operation performed by a user. In the data acquisition mode, each AGV 10 starts acquiring sensor data by using the LRF.

The location estimation device accumulates the sensor data in its storage device. Upon completion of acquisition of the sensor data in the environment S. the sensor data accumulated in the storage device is transmitted to an external device. The external device is a computer which includes, for example, a signal processor and on which a map generation computer program is installed.

The signal processor of the external device superimposes pieces of the sensor data, acquired for each round of scanning, on top of each other. The signal processor repeatedly performs the superimposing process, making it possible to generate a map of the environment S. The external device transmits data on the generated map to each AGV 10. Each AGV 10 stores the data on the generated map in an internal storage device. The external device may be the operation management device 50 or any other device.

Instead of the external device, each AGV 10 may generate a map. The process performed by the signal processor of the external device described above may be performed by a circuit, such as a microcontroller unit (or microcontroller) of each AGV 10. When a map is generated in each AGV 10, the accumulated sensor data does not need to be transmitted to the external device. The data volume of the sensor data is generally believed to be large. Because the sensor data does not need to be transmitted to the external device, a communication line will not be occupied.

Movement within the environment S for acquisition of sensor data may be enabled by travel of each AGV 10 in accordance with an operation performed by the user. For example, each AGV 10 wirelessly receives, from the user through the terminal device 20, a travel command that instructs each AGV 10 to move in each of the front/rear/right/left directions. Each AGV 10 travels in the front/rear/right/left directions in the environment S in accordance with the travel command so as to generate a map. When each AGV 10 is connected by wire to an operating device, such as a joystick, each AGV 10 may travel in the front/rear/right/left directions in the environment S in accordance with a control signal from the operating device so as to generate a map. A person may walk while pushing a measuring car equipped with an LRF, thus acquiring sensor data.

Although FIGS. 18 and 19 illustrate a plurality of the AGVs 10, there may only be one AGV. When a plurality of the AGVs 10 are present, the user 1 may select, by using the terminal device 20, one of the registered AGVs 10 to generate a map of the environment S.

Upon generation of the map, each AGV 10 is able to, from then on, perform automated travel while estimating its own location using the map.

### (3) Configuration of AGV

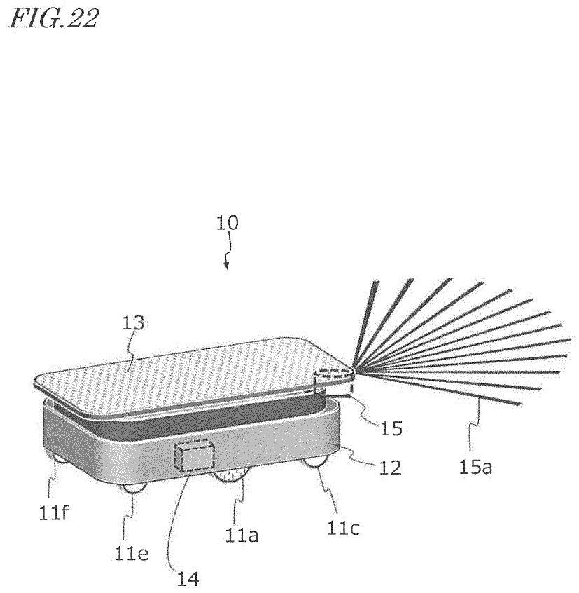

FIG. 22 is an external view of an illustrative AGV 10 according to the present example embodiment. The AGV 10 includes two driving wheels 11a and 11b, four casters 11c, 11d, 11e, and 11f, a frame 12, a carriage table 13, a travel control unit 14, and an LRF 15. The two driving wheels 11a and 11b are each provided on an associated one of the right and left portions of the AGV 10. The four casters 11c, 11d, 11e, and 11f are each disposed on an associated one of the four corners of the AGV 10. Although the AGV 10 further includes a plurality of motors connected to the two driving wheels 11a and 11b, the motors are not shown in FIG. 22. FIG. 22 illustrates the single driving wheel 11a and the two casters 11c and 11e located on the right portion of the AGV 10, and the caster 11f located on the left rear portion of the AGV 10. The left driving wheel 11b and the left front caster 11d are obscured behind the frame 12 and are thus not visible. The four casters 11c, 11d, 11e, and 11f are able to turn freely. In the following description, the driving wheel 11a and the driving wheel 11b may respectively be referred to as a “wheel 11a” and a “wheel 11b”.

The travel control unit 14 is a unit to control the operation of the AGV 10. The travel control unit 14 includes an integrated circuit whose main component is a microcontroller (which will be described below), an electronic component(s), and a substrate on which the integrated circuit and the electronic component(s) are mounted. The travel control unit 14 receives and transmits data from and to the terminal device 20 described above and performs preprocessing computations.

The LRF 15 is an optical instrument that emits, for example, infrared laser beams 15a and detects reflected light of each laser beam 15a, thus measuring a distance to a point of reflection. In the present example embodiment, the LRF 15 of the AGV 10 emits the laser beams 15a in a pulsed form to, for example, a space in the range of 135 degrees to the right and to the left (for a total of 270 degrees) with respect to the front surface of the AGV 10 while changing the direction of each laser beam 15a by every 0.25 degrees, and detects reflected light of each laser beam 15a. This makes it possible to obtain, for every 0.25 degrees, data on a distance to a point of reflection in a direction determined by an angle corresponding to a total of 1081 steps. In the present example embodiment, the LRF 15 scans its surrounding space in a direction substantially parallel to a floor surface, which means that the LRF 15 performs planar (or two-dimensional) scanning. The LRF 15, however, may perform scanning in a height direction.

The AGV 10 is able to generate a map of the environment S in accordance with the location and attitude (or orientation) of the AGV 10 and scanning results obtained by the LRF 15. The map may be reflective of the location(s) of a structure(s), such as a wall(s) and/or a pillar(s) around the AGV, and/or an object(s) placed on a floor. Data on the map is stored in a storage device provided in the AGV 10.

The location and attitude, i.e., the pose (x, y, θ), of the AGV 10 may hereinafter be simply referred to as a “location”.

The travel control unit 14 compares measurement results obtained by the LRF 15 with map data retained in itself so as to estimate its own current location in the manner described above. The map data may be map data generated by the other AGV(s) 10.

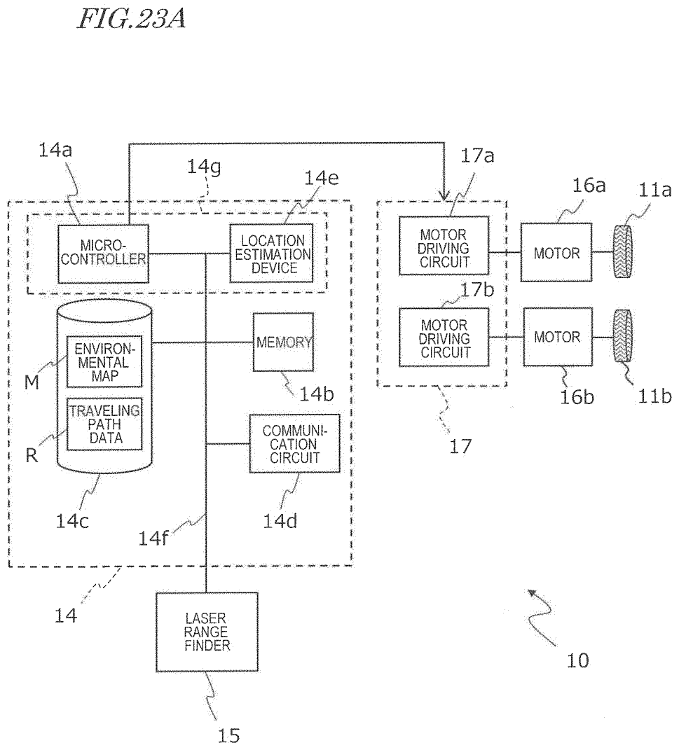

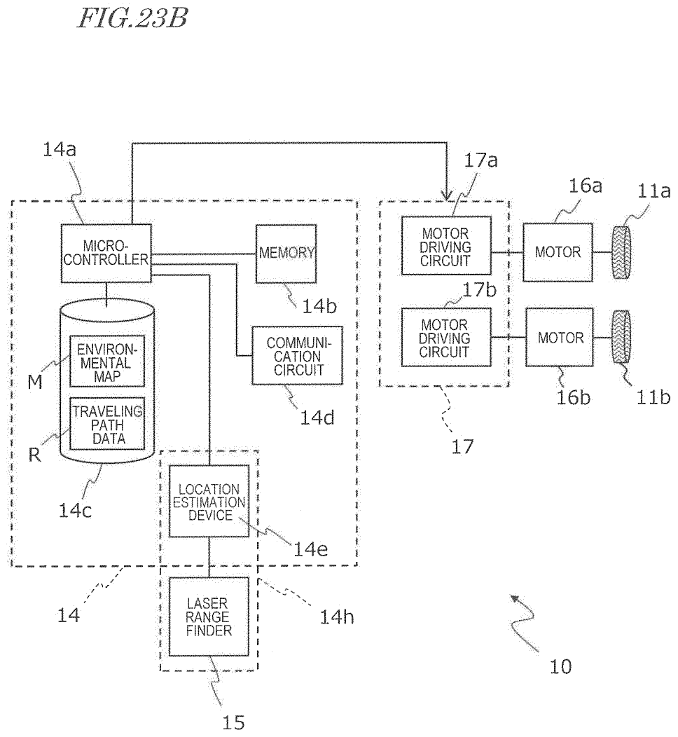

FIG. 23A illustrates a first example hardware configuration of the AGV 10. FIG. 23A also illustrates in detail a configuration of the travel control unit 14.

The AGV 10 includes the travel control unit 14, the LRF 15, two motors 16a and 16b, a driving unit 17, and the wheels 11a and 11b.

The travel control unit 14 includes a microcontroller 14a, a memory 14b, a storage device 14c, a communication circuit 14d, and a location estimation device 14e. The microcontroller 14a, the memory 14b, the storage device 14c, the communication circuit 14d, and the location estimation device 14e are connected to each other through a communication bus 14f and are thus able to exchange data with each other. The LRF 15 is also connected to the communication bus 14f through a communication interface (not shown) and thus transmits measurement data (which is measurement results) to the microcontroller 14a, the location estimation device 14e, and/or the memory 14b.

The microcontroller 14a is a processor or a control circuit (e.g., a computer) that performs computations to control the entire AGV 10 including the travel control unit 14. The microcontroller 14a is typically a semiconductor integrated circuit. The microcontroller 14a transmits a pulse width modulation (PWM) signal (which is a control signal) to the driving unit 17 and thus controls the driving unit 17 so as to adjust voltages to be applied to the motors. This rotates each of the motors 16a and 16b at a desired rotation speed.

One or more control circuits (e.g., one or more microcontrollers) to control driving of the left motor 16a and the right motor 16b may be provided independently of the microcontroller 14a. For example, the driving unit 17 may include two microcontrollers each of which controls driving of an associated one of the motors 16a and 16b.

The memory 14b is a volatile storage device to store a computer program to be executed by the microcontroller 14a. The memory 14b may also be used as a working memory when the microcontroller 14a and the location estimation device 14e perform computations.

The storage device 14c is a non-volatile semiconductor memory device. Alternatively, the storage device 14c may be a magnetic storage medium, such as a hard disk, or an optical storage medium, such as an optical disc. The storage device 14c may include a head device to write and/or read data to and/or from any of the storage media, and a controller for the head device.

The storage device 14c stores: map data (e.g., the environmental map M including a plurality of partial environmental maps) on the environment S in which the AGV 10 travels; and data on one or a plurality of traveling paths (i.e., traveling path data R). The environmental map M may be generated by operating the AGV 10 in a map generating mode and may be stored in the storage device 14c. The traveling path data R is transmitted from outside after the map M is generated. In the present example embodiment, the environmental map M and the traveling path data R are stored in the same storage device 14c. Alternatively, the environmental map M and the traveling path data R may be stored in different storage devices.

An example of the traveling path data R will be described below.

When the terminal device 20 is a tablet computer, the AGV 10 receives, from the tablet computer, the traveling path data R indicative of a traveling path(s). The traveling path data R in this case includes marker data indicative of the locations of a plurality of markers. The “markers” indicate locations (or passing points) to be passed by the traveling AGV 10. The traveling path data R includes at least location information on a start marker indicative of a travel start location and an end marker indicative of a travel end location. The traveling path data R may further include location information on a marker(s) indicative of one or more intermediate passing points. Supposing that a traveling path includes one or more intermediate passing points, a path extending from the start marker and sequentially passing through the travel passing points so as to reach the end marker is defined as a “traveling path”. Data on each marker may include, in addition to coordinate data on the marker, data on the orientation (or angle) and traveling velocity of the AGV 10 until the AGV 10 moves to the next marker. When the AGV 10 temporarily stops at the location of each marker, performs localization, and provides, for example, notification to the terminal device 20, the data on each marker may include data on acceleration time required for acceleration to reach the traveling velocity, and/or deceleration time required for deceleration from the traveling velocity so as to stop at the location of the next marker.

Instead of the terminal device 20, the operation management device 50 (e.g., a PC and/or a server computer) may control movement of the AGV 10. In this case, each time the AGV 10 reaches a marker, the operation management device 50 may instruct the AGV 10 to move to the next marker. From the operation management device 50, for example, the AGV 10 receives, in the form of the traveling path data R of a traveling path(s), coordinate data of a target location (which is the next destination) or data on a distance to the target location and an angle at which the AGV 10 should travel.

The AGV 10 is able to travel along the stored traveling path(s) while estimating its own location using the generated map and the sensor data acquired during travel and output from the LRF 15.

The communication circuit 14d is, for example, a wireless communication circuit to perform wireless communication compliant with Bluetooth (registered trademark) standards and/or Wi-Fi (registered trademark) standards. The Bluetooth standards and Wi-Fi standards both include a wireless communication standard that uses a frequency band of 2.4 GHz. For example, in a mode of generating a map by running the AGV 10, the communication circuit 14d performs wireless communication compliant with Bluetooth (registered trademark) standards so as to communicate with the terminal device 20 on a one-to-one basis.

The location estimation device 14e performs the process of generating a map and the process of estimating, during travel, its own location. The location estimation device 14e generates a map of the environment S in accordance with the location and attitude of the AGV 10 and scanning results obtained by the LRF. During travel, the location estimation device 14e receives sensor data from the LRF 15 and reads the environmental map M stored in the storage device 14c. Local map data (or sensor data) generated from the scanning results obtained by the LRF 15 is matched against the environmental map M covering a larger range, thus identifying its own location (x, y, θ) on the environmental map M. The location estimation device 14e generates data on “reliability” indicative of the degree of agreement between the local map data and the environmental map M. The respective data of its own location (x, y, θ) and reliability may be transmitted from the AGV 10 to the terminal device 20 or the operation management device 50. The terminal device 20 or the operation management device 50 is able to receive the respective data of its own location (x, y, θ) and reliability and present the location (x, y, θ) and the data on a display device built into the terminal device 20 or the operation management device 50 or connected thereto.

In the present example embodiment, the microcontroller 14a and the location estimation device 14e are separate components by way of example. Alternatively, a single chip circuit or semiconductor integrated circuit that enables the microcontroller 14a and the location estimation device 14e to operate independently may be provided. FIG. 23A illustrates a chip circuit 14g that includes the microcontroller 14a and the location estimation device 14e. The following description discusses an example where the microcontroller 14a and the location estimation device 14e are provided separately and independently.

The two motors 16a and 16b are each attached to an associated one of the two wheels 11a and 11b so that each wheel is rotated. In other words, each of the two wheels 11a and 11b is a driving wheel. Each of the motors 16a and 16b is described herein as a motor to drive an associated one of the right and left wheels of the AGV 10.

The driving unit 17 includes motor driving circuits 17a and 17b to adjust voltages to be applied to the two motors 16a and 16b. The motor driving circuits 17a and 17b each include an “inverter circuit”. The motor driving circuits 17a and 17b each turn on and off a current flowing through an associated one of the motors by a PWM signal transmitted from the microcontroller 14a or a microcontroller in the motor driving circuit 17a, thus adjusting a voltage to be applied to an associated one of the motors.

FIG. 23B illustrates a second example hardware configuration of the AGV 10. The second example hardware configuration differs from the first example hardware configuration (FIG. 23A) in that a laser positioning system 14h is provided and the microcontroller 14a is connected to each component on a one-to-one basis.

The laser positioning system 14h includes the location estimation device 14e and the LRF 15. The location estimation device 14e and the LRF 15 are connected through, for example, an Ethernet (registered trademark) cable. The location estimation device 14e and the LRF 15 each operate as described above. The laser positioning system 14h outputs information indicative of the pose (x, y, θ) of the AGV 10 to the microcontroller 14a.

The microcontroller 14a includes various general-purpose I/O interfaces or general-purpose input and output ports (not shown). The microcontroller 14a is directly connected through the general-purpose input and output ports to other components in the travel control unit 14, such as the communication circuit 14d and the laser positioning system 14h.

The configuration of FIG. 23B is similar to the configuration of FIG. 23A except the features described above with reference to FIG. 23B. Description of the similar features will thus be omitted.

The AGV 10 according to an example embodiment of the present disclosure may include safety sensors, such as an obstacle detecting sensor and a bumper switch (not shown).

### (4) Configuration Example of Operation Management Device

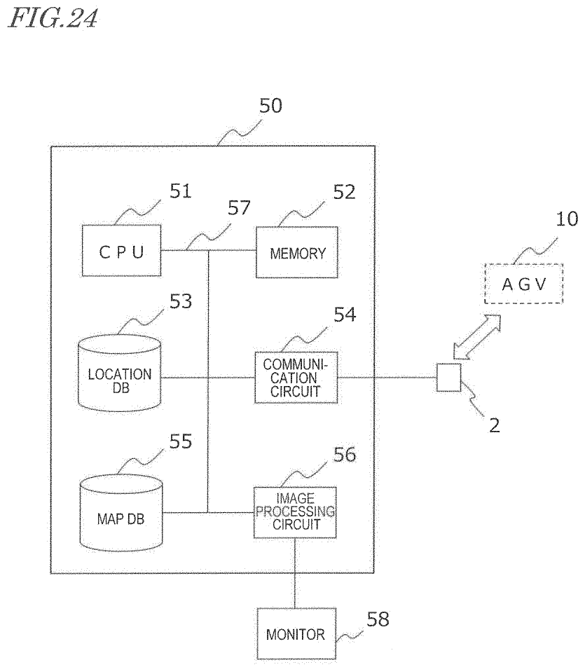

FIG. 24 illustrates an example hardware configuration of the operation management device 50. The operation management device 50 includes a CPU 51, a memory 52, a location database (location DB) 53, a communication circuit 54, a map database (map DB) 55, and an image processing circuit 56.

The CPU 51, the memory 52, the location DB 53, the communication circuit 54, the map DB 55, and the image processing circuit 56 are connected to each other through a communication bus 57 and are thus able to exchange data with each other.

The CPU 51 is a signal processing circuit (computer) to control the operation of the operation management device 50. The CPU 51 is typically a semiconductor integrated circuit.

The memory 52 is a volatile storage device to store a computer program to be executed by the CPU 51. The memory 52 may also be used as a working memory when the CPU 51 performs computations.

The location DB 53 stores location data indicative of each location that may be a destination for each AGV 10. The location data may be represented, for example, by coordinates virtually set in a factory by an administrator. The location data is determined by the administrator.

The communication circuit 54 performs wired communication compliant with, for example, Ethernet (registered trademark) standards. The communication circuit 54 is connected by wire to the access points 2 (FIG. 18) and is thus able to communicate with the AGV 10 through the access points 2. Through the bus 57, the communication circuit 54 receives, from the CPU 51, data to be transmitted to the AGV 10. The communication circuit 54 transmits data (or notification), which has been received from the AGV 10, to the CPU 51 and/or the memory 52 through the bus 57.

The map DB 55 stores data on maps of the inside of, for example, a factory where each AGV 10 travels. When the maps each have a one-to-one corresponding relationship with the location of an associated one of the AGVs 10, the data may be in any format. The maps stored, for example, in the map DB 55 may be maps generated by CAD.

The location DB 53 and the map DB 55 may be generated on a non-volatile semiconductor memory, a magnetic storage medium, such as a hard disk, or an optical storage medium, such as an optical disc.

The image processing circuit 56 is a circuit to generate data on an image to be presented on a monitor 58. The image processing circuit 56 is operated exclusively when the administrator operates the operation management device 50. In the present example embodiment, we will not go into any further details on this point. The monitor 58 may be integral with the operation management device 50. The CPU 51 may perform the processes to be performed by the image processing circuit 56.

In the foregoing example embodiment, an AGV that travels in a two-dimensional space (e.g., on a floor surface) has been described by way of example. The present disclosure, however, may be applicable to a vehicle that moves in a three-dimensional space, such as a flying vehicle (e.g., a drone). In the case where a drone generates a map of a three-dimensional space while flying, a two-dimensional space can be extended to a three-dimensional space.

The comprehensive example embodiment described above may be implemented by a system, a method, an integrated circuit, a computer program, or a storage medium. Alternatively, the comprehensive example embodiment described above may be implemented by any combination of a system, a device, a method, an integrated circuit, a computer program, and a storage medium.

Vehicles according to example embodiments of the present disclosure may be suitably used to move and convey articles (e.g., cargo, components, and finished products) in places, such as, factories, warehouses, construction sites, distribution centers, and hospitals.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-8. (canceled)

9. A vehicle comprising:
an external sensor to scan an environment so as to periodically output scan data;
a storage to store a plurality of partial environmental maps including a first partial environmental map and a second partial environmental map linked to each other based on a coordinate transformation relationship; and
a location estimator to match the scan data against one of the plurality of partial environmental maps read from the storage so as to estimate a location and an attitude of the vehicle; wherein
upon movement of the estimated location of the vehicle from a location on the first partial environmental map to a location on the second partial environmental map, the location estimator performs:
determining, in accordance with the coordinate transformation relationship, a corresponding location and a corresponding attitude on the second partial environmental map that are associated with the estimated location and estimated attitude of the vehicle on the first partial environmental map;
correcting, in accordance with a history of estimated locations and estimated attitudes of the vehicle on the first partial environmental map, the corresponding location and corresponding attitude on the second partial environmental map at a point of timing when matching to estimate the location and attitude of the vehicle on the second partial environmental map starts; and
executing the matching to estimate the location and attitude of the vehicle on the second partial environmental map by using, as initial values, the corresponding location and corresponding attitude that have been corrected.

10. The vehicle according to claim 9, wherein the location estimator determines a moving velocity of the vehicle on the first partial environmental map in accordance with the history of estimated locations and estimated attitudes of the vehicle on the first partial environmental map, and predicts, in accordance with the moving velocity, a location and an attitude of the vehicle on the second partial environmental map at the point of timing.

11. The vehicle according to claim 9, wherein the location estimator performs the matching by using an iterative closest point algorithm.

12. The vehicle according to claim 9, further comprising one of an omnidirectional wheel, a two-legged walking device, and a multi-legged walking device.

13. The vehicle according to claim 9, further comprising a display to present, using an image and/or a sound, the location or the location and attitude of the vehicle as estimated by the location estimator.

14. The vehicle according to claim 13, further comprising a navigation device to guide a user through a path in accordance with a destination and the location and attitude of the vehicle as estimated by the location estimator.

15. A location estimation device of a vehicle, the location estimation device being connected to:
an external sensor to scan an environment so as to periodically output scan data; and
a storage to store a plurality of partial environmental maps including a first partial environmental map and a second partial environmental map linked to each other based on a coordinate transformation relationship; wherein
the location estimation device comprises:
a processor; and
a memory to store a computer program to operate the processor; wherein
upon movement of an estimated location of the vehicle from a location on the first partial environmental map to a location on the second partial environmental map, the processor performs, in accordance with a command included in the computer program:
determining, in accordance with the coordinate transformation relationship, a corresponding location and a corresponding attitude on the second partial environmental map that are associated with the estimated location and estimated attitude of the vehicle on the first partial environmental map;
correcting, in accordance with a history of estimated locations and estimated attitudes of the vehicle on the first partial environmental map, the corresponding location and corresponding attitude on the second partial environmental map at a point of timing when matching to estimate the location and attitude of the vehicle on the second partial environmental map starts; and
executing the matching to estimate the location and attitude of the vehicle on the second partial environmental map by using, as initial values, the corresponding location and corresponding attitude that have been corrected.

16. A non-transitory computer-readable storage medium having stored thereon a computer program to be used in the location estimation device according to claim 15.
